(19) United States
(12) Patent Application Publication
(10) Pub. No.: US 2026/0172777 A1
(43) Pub. Date: Jun. 18, 2026

(54) METHODS, ARCHITECTURES, APPARATUSES AND SYSTEMS FOR SENSING GROUP SETUP IN A MOVING TARGET SENSING SERVICE AREA

(71) Applicant: InterDigital Patent Holdings, Inc., Wilmington, DE (US)

(72) Inventors: Filipe Conceicao, London (GB); Sebastian Robitzsch, London (GB); Muhammad Awais Jadoon, London (GB); Abinaya Babu, Illford (GB)

(21) Appl. No.: 18/981,357

(22) Filed: Dec. 13, 2024

(51) Int. Cl. H04W 4/021; H04W 4/02; H04W 76/14

(52) U.S. Cl. CPC H04W 4/021; H04W 4/026; H04W 76/14

(57) ABSTRACT

Procedures, methods, architectures, apparatuses, systems, devices, and computer program products are provided for setup of a sensing group within a moving TSSA. For example, configuration information indicating an mTSSA associated with the WTRU may be determined. A ProSe announcement may be transmitted to identify a discoverer WTRU. A sidelink connection may be established with the discoverer WTRU, and location information may be received from the discoverer WTRU. A sensing group may be determined within the mTSSA based on the received location information, and sensing group information associated with the sensing group may be transmitted to the wireless network.

### TECHNICAL FIELD

The present disclosure is generally directed to the fields of communications, software and encoding, including, for example, to methods, architectures, apparatuses, systems related to the setup of sensing groups in a moving target sensing service area.

### SUMMARY

Methods performed by a device which may be a WTRU are provided. In some embodiments, the method may include determining configuration information indicating a moving target sensing service area (mTSSA) associated with the WTRU. The method may also include transmitting a proximity-based service (ProSe) announcement to identify a discoverer WTRU. The method may also include establishing a sidelink connection with the discoverer WTRU based on the transmitted or received request, and receiving, from the discoverer WTRU, location information. The method may also include determining a sensing group within the mTSSA based on the received location information, and transmitting sensing group information associated with the determined sensing group to the wireless network.

In some embodiments, a WTRU including a process and a transceiver is provided for determining a sensing group. The WTRU may be configured to determine configuration information indicating a mTSSA associated with the WTRU. The WTRU may also be configured to transmit a ProSe announcement to identify a discoverer WTRU. The WTRU may also be configured to establish a sidelink connection with the discoverer WTRU based on the transmitted or received request, and receive, from the discoverer WTRU, location information. The WTRU may also be configured to determine a sensing group within the mTSSA based on the received location information, and transmit sensing group information associated with the determined sensing group to the wireless network

In certain representative embodiments, determining the configuration information indicating the mTSSA comprises receiving configuration information from the wireless network.

In certain representative embodiments, determining the configuration information indicating the mTSSA is based on a pre-configured mTSSA.

In certain representative embodiments, the mTSSA has a location and the location is determined relative to the WTRU.

In certain representative embodiments, the WTRU is located inside or outside the mTSSA associated with the WTRU.

In certain representative embodiments, the mTSSA has a displacement orientation and the displacement orientation is determined based on a movement direction of the WTRU.

The methods and systems may also include receiving sensing data or sensing results from a WTRU of the sensing group.

In certain representative embodiments, the sensing group information comprises at least one of a relative location in relation to the WTRU or the discoverer WTRU, a relative velocity in relation to the WTRU or the discoverer WTRU, a range or direction in relation to the WTRU or the discoverer WTRU, or a list of WTRUs.

In certain representative embodiments, determining the sensing group within the mTSSA based on the received location information comprises determining the sensing group within the mTSSA based on ranging information.

The methods and systems may also include, subsequent to determining the sensing group, determining a location of the WTRU, and determining updated configuration information indicating an updated mTSSA based on the location of the WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows an example scenario in which a target WTRU is installed in a vehicle and is associated with an mTSSA, according to some embodiments of the present disclosure;

FIG. 3 is a flow diagram of illustrative steps involved in an example message sequence between multiple network entities for setting up sensing groups in an mTSSA, according to some embodiments of the present disclosure;

FIG. 4A is a diagram of an example system illustrating a determination of a sensing group from a group of WTRUs, according to some embodiments of the present disclosure;

FIG. 4B is a diagram of an example system illustrating a determination of a sensing group from a group of WTRUs, according to some embodiments of the present disclosure;

FIG. 5 shows new exemplary functions for sensing operations, according to some embodiments of the present disclosure; and

FIG. 6 shows a flow diagram illustrating a method for the setup of sensing groups in a moving target sensing service area in accordance with some embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

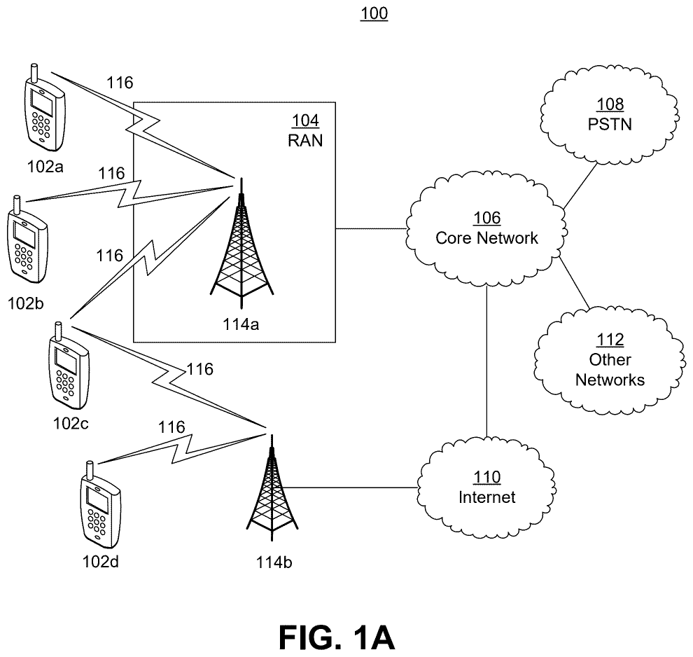

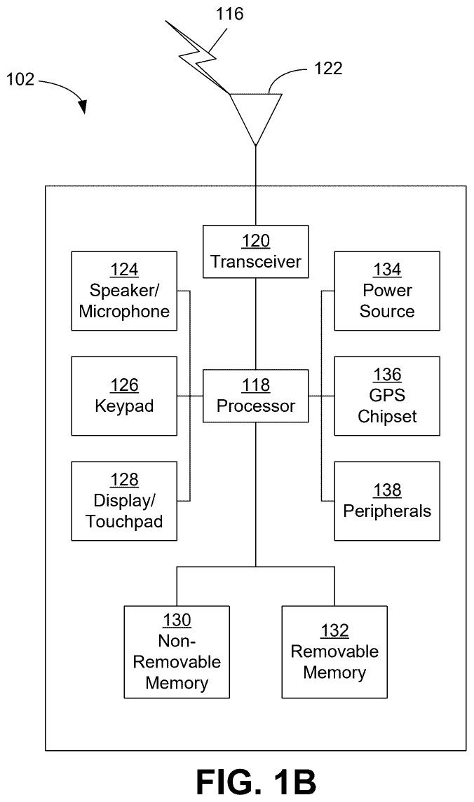

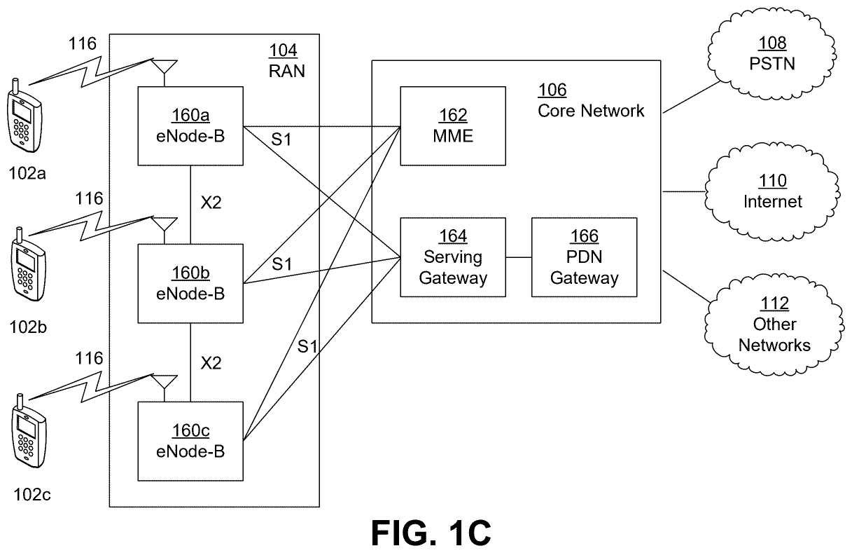

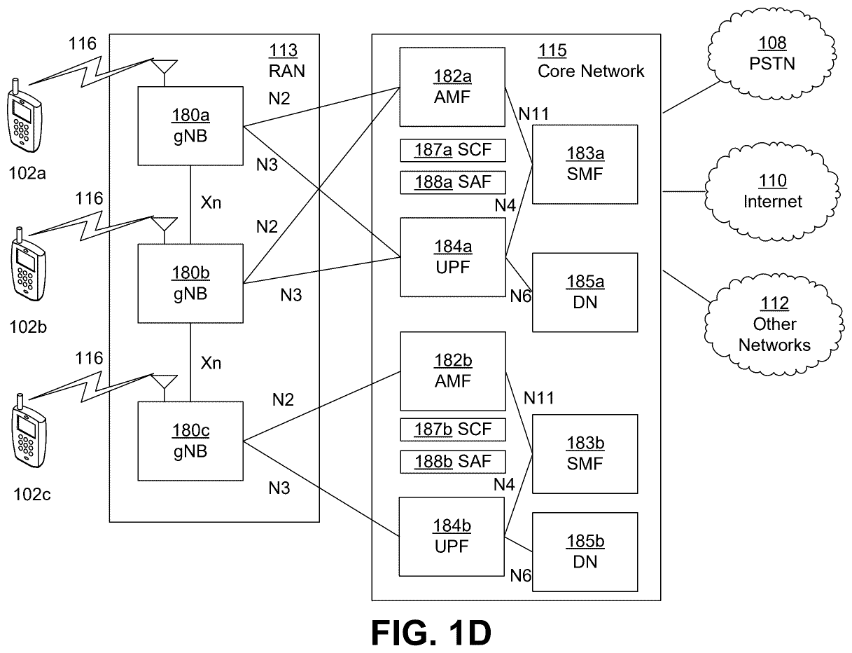

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, at least one Sensing Coordination Function (SCF) 187a, 187b, and at least one Sensing Analytics Function (SAF) 188a, 188b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As described herein, the term ‘3GPP sensing data’ may comprise data derived from 3GPP radio signals impacted (e.g., reflected, refracted, and diffracted) by an object or environment of interest for sensing purposes, and which may in some cases be processed within a 5G system.

As described herein, the term ‘non-3GPP sensing data’ may comprise data provided by non-3GPP sensors (e.g., video, LiDAR, sonar) about an object or environment of interest for sensing purposes.

As described herein, the term ‘sensing result’ may comprise processed 3GPP sensing data requested by a service consumer.

As described herein, the term ‘sensing contextual information’ may comprise information that is exposed with sensing results by a 5G system to a trusted third-party which provides context to conditions under which the sensing results were derived. In some examples, the information does not contain 3GPP sensing data.

As described herein, the term ‘5G Wireless sensing’ may comprise a 5GS feature which may provide capabilities to obtain information about characteristics of an environment and/or objects within the environment (e.g., shape, size, orientation, speed, location, distances or relative motion between objects, etc) using New Radio (NR) radio frequency signals, which, in some cases, can be extended by information created via previously specified functionalities in EPC and/or Evolved Universal Terrestrial Radio Access Network (E-UTRAN).

As described herein, the term ‘sensing assistance information’ may comprise information that is provided to a 5G system from a trusted third-party and can be used to support the derivation of a sensing result. In examples, such information does not contain 3GPP sensing data.

As described herein, the term ‘sensing group’ may comprise a set of sensing transmitters and sensing receivers whose location is known and whose sensing data can be collected synchronously.

As described herein, the term ‘sensing receiver’ may comprise an entity that may receive a sensing signal which a sensing service may use in its operation. The sensing receiver may be part of a RAN node or a WTRU. The sensing receiver may be located in a same or different entity as a sensing transmitter.

As described herein, the term ‘sensing transmitter’ may comprise an entity that may send out a sensing signal which a sensing service may use in its operation. The sensing transmitter may be part of a RAN node or a WTRU. The sensing transmitter may be located in a same or different entity as a sensing receiver.

As described herein, the term ‘sensing signals’ may comprise transmissions on the 3GPP radio interface that may be used for sensing purposes.

As described herein, the term ‘sensing modes’ may comprise monostatic, bi-static, multi-static sensing, regardless of a sensing transmitter and receiver pair, e.g., in an example with a WTRU and a base station (BS), or in another example with a first WTRU and second WTRU. In some examples, one of the WTRU and BS of a WTRU/BS pair may be a transmitter and the other one a receiver or vice versa. Similarly, one of the first WTRU and second WTRU of a first WTRU/second WTRU pair may be a transmitter and the other one a receiver or vice versa.

As described herein, the term ‘sensing QoS’ may comprise any measure of quality of at least one of sensing data, result (e.g., location result) and contextual information. In some instances, quality may relate to at least one of integrity of a measurement, Quality is an assessment of a suitability and trustability of at least one of sensing data, result (e.g., location result) and/or contextual information. Quality may be measured using different methodologies and expressed in different metrics. Different metrics may include error percentages and margins, commonly used statistical measures for error difference between ground truth values (if available) and measured values (e.g., Root Mean Square Error (RMSE)), estimator function related error calculations, etc. Different methodologies may include assessment of one or more samples of at least one of sensing data, result (e.g., location result), and contextual information, by the application of any heuristic, statistical, probabilistic, AI/ML related methods, etc.

As described herein, the term ‘positioning integrity’ may comprise a measure of the trust in the accuracy of the position-related data provided by the positioning system and the ability to provide timely and valid warnings to the LCS client when the positioning system does not fulfil the condition for intended operation.

As described herein, the term ‘sensing reporting’ may comprise a transmission of a report containing sensing data and/or results and/or contextual information, in raw or processed form.

As described herein, ProSe discovery is a mechanism by which one of two or more nearby wireless transmit/receive units (WTRUs) may determine a presence of another one of the two or more nearby WTRUs in order to establish a sidelink connection. As described herein, the location of a target WTRU may be characterized using one or more location result parameters such as range and direction, relative location, and/or relative velocity.

As such, in some examples, a range may refer to a straight line distance between the target WTRU and another WTRU, such as another target WTRU, a located WTRU or a sidelink Reference WTRU (SL Reference WTRU). A direction may refer to a direction to the target WTRU from another WTRU (e.g., another target WTRU, a Located WTRU or a SL Reference WTRU). In some cases, a direction may refer to a direction from the target WTRU to another WTRU (e.g., another target WTRU, a Located WTRU or a SL Reference WTRU).

In some examples, a relative location may refer to a location of a target WTRU relative to a network element or another WTRU. For instance, the relative location may be a relative 2D location with an uncertainty ellipse. In some cases, relative location may be a relative 3D location with an uncertainty ellipsoid.

In some examples, relative velocity may refer to a velocity of a target WTRU relative to another WTRU. A relative velocity of a target WTRU may include a radial component between the target WTRU and the other WTRU and a transverse component which may be at right angles or perpendicular to the radial component.

As described herein, the term target sensing service area (TSSA) may mean an area to be sensed. The TSSA may be a cartesian location area that is to be sensed by deriving characteristics of an environment for example an indoor environment and/or an outdoor environment, and/or characteristics of objects within the environment, and in some cases, may be associated with a certain sensing service quality from the impacted for example reflected, refracted, and diffracted radio signals.

In some cases, a TSSA may move or be physically displaced. This may give rise to a moving TSSA (mTSSA) as described herein. By way of illustration, a V2X scenario may be considered in which an area to be sensed (a TSSA), is mobile, and may for example be associated with, pinned to, or originating from a target WTRU. Such a target WTRU may for example, be installed in a vehicle. As the vehicle moves, the mTSSA moves as well.

In some cases, the parameters and/or location of the mTSSA may change, and updated configuration parameters and/or location information of the mTSSA may be determined.

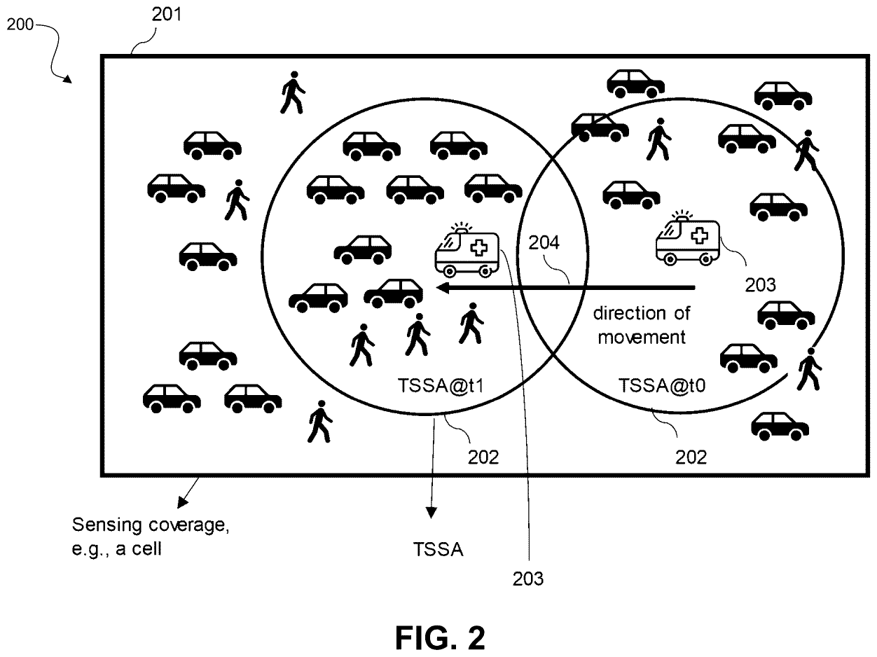

FIG. 2 shows an example scenario 200 in which a target WTRU 203, which, in the example shown, may be installed in a vehicle, is associated with a moving target sensing service area (mTSSA) 202 according to some embodiments of the present disclosure.

In the example shown, the mTSSA 202 may be pinned to the target WTRU 203 which may move. In the example shown in FIG. 2, the target WTRU 203 moves from right to left. As illustrated, the mTSSA 202 may have a respective range and shape around the target WTRU 302, and in the example shown in FIG. 2, the mTSSA 202 is circular. The mTSSA may be a two-dimensional or three-dimensional shape, and may take any suitable shape. In examples where the mTSSA is two-dimensional, the mTSSA may be circular, elliptical, polygonal, multi-sided, square, rectangular, or any suitable shape. The mTSSA may be an irregular shape, or a shape which may be modelled by any one or more mathematical functions. In examples where the mTSSA is three-dimensional, the mTSSA may be spherical, ovoid, cone-shaped, pyramidal, ellipsoid, multi-faced, or any suitable shape. The mTSSA may be an irregular volume, or a volume which may be modelled by any one or more mathematical functions.

The target WTRU 203 may be the origin of the mTSSA, such that the target WTRU 203 lies within the mTSSA, or may lie outside the mTSSA. In the example shown in FIG. 2, the target WTRU 203 is within the mTSSA 202. The mTSSA may have a location and the location of the mTSSA may be determined relative to the target WTRU 203. In some examples the mTSSA 203 has an orientation and the orientation may be determined based on a movement direction of the target WTRU 203. In an example, the mTSSA 202 may be conical and the ‘point’ of the cone may be associated with the target WTRU 203, such that when the target WTRU 203 moves, the conical mTSSA 202 moves. In the case that the target WTRU 203 is a vehicle, the mTSSA 202 may extend away from the target WTRU 203 and in the direction of travel of the target WTRU 203. The mTSSA may, for example, be defined or generated based on a requirement for autonomous driving of a vehicle, such that obstacles, other road users, or other information may be sensed. In an example, the orientation may be a displacement orientation and may, for example, be a segment or sector of a circle, such that the segment or portion of the circle which forms the mTSSA has a particular displacement orientation with respect to the WTRU. For example, the mTSSA may be a segment of a circle in front of a WTRU in the direction of displacement or travel of the WTRU. In some examples, the mTSSA may be shaped appropriately for autonomous driving. In an autonomous driving example, the mTSSA may be conical or wedge-shaped and may be pinned to the vehicle, extending outwardly therefrom. In some examples, the mTSSA may extend in the direction of travel of the vehicle. In some examples, the mTSSA may be generated such that, in low lighting or poor visibility conditions, information about the road or landscape ahead may be sensed.

Returning to a discussion of FIG. 2, in the example shown, at instant time t₀, target WTRU 203 is located within mTSSA 202, which may in turn be located within a sensing coverage area 201 (e.g., a cell). In the example shown, target WTRU 203 moves from right to left (as illustrated by arrow 204) such that at instant time t₁. At the time instants t₀ and t₁, there may be other WTRUs (e.g., moving, stationary) within sensing coverage area 201 apart from target WTRU 203. At the instant time t₀, a first portion of the other WTRUs may be located within the mTSSA 202. At the instant time t₁, a second portion of the other WTRUs may be located within the mTSSA 202.

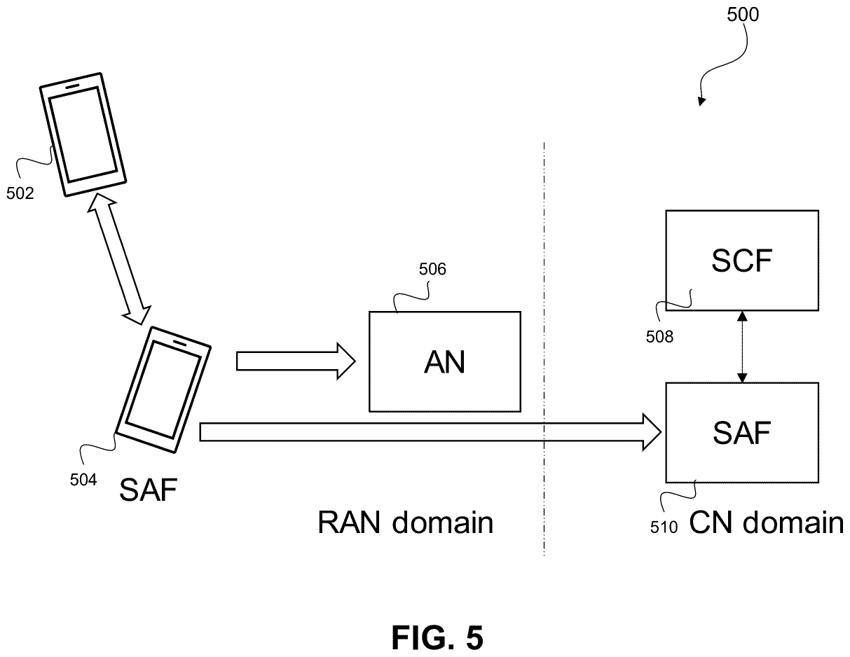

At the time instants t₀ and t₁, the target WTRU 203, which in this example is installed in a vehicle may be in different locations as the vehicle may be moving. Therefore, the mTSSA being associated with the target WTRU may be in different locations. At both the time instants t₀ and t₁, a composition of a group of WTRUs, for example a sensing group, that may be geographically within the mTSSA may be different. In some instances, each WTRU of the group of WTRUs may comprise any type of device such as a smartphone which may, for example, be on a pedestrian or a cyclist, a connected vehicle of any kind, and/or a fixed mounted sensing entity which may be deployed to aid sensing operations (for example, a sign gantry on a motorway). FIG. 5 also depicts other WTRUs which may not be part of the sensing group of WTRUs at t₀ or t₁.

In some instances, the target WTRU 203 may be provided with sensing assisted information by request of a digital twin (DT) or the target WTRU. FIG. 5 also shows an exemplary sensing coverage area. In some examples, the sensing coverage area may be one or more cells (e.g., a main cell and adjacent cells), a target area (TA) which may, for example be a legacy TA, or any other form of area identification.

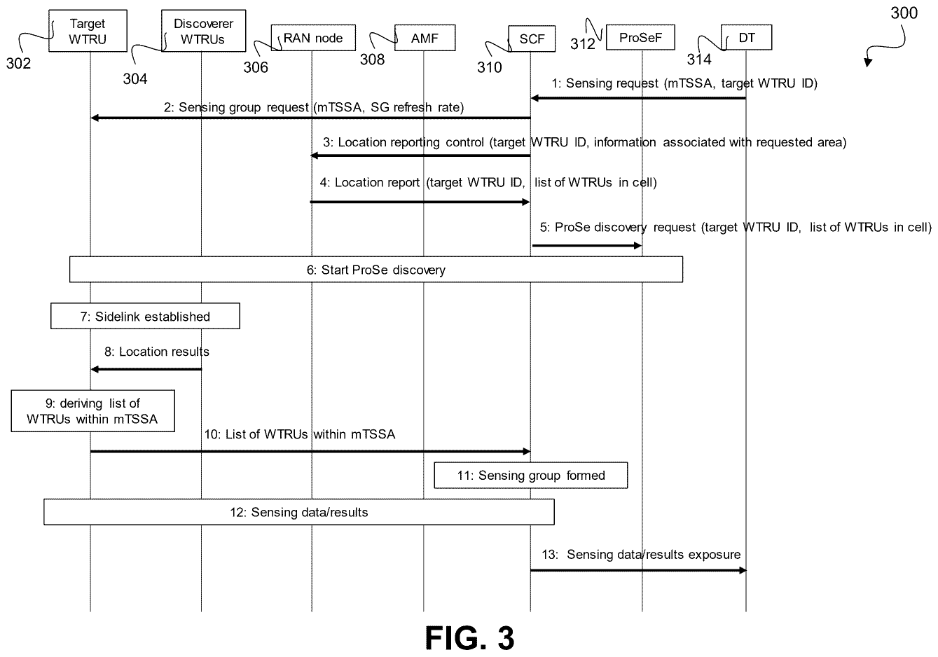

FIG. 3 illustrates an exemplary diagram 300 of illustrative steps involved in an example message sequence across multiple network entities which include a target WTRU 302, discoverer WTRUs 304, a RAN node 306, an AMF 308, a Sensing Control Function (SCF) 310 which may be the SCF 187a, 187b of FIG. 1D, a ProSe Function (ProSeF) 312, and a Digital Twin (DT) 314, according to some embodiments of the present disclosure.

In some cases, the DT 314 may control a WTRU which may be within or part of a car, and in some examples, the DT 314 may initiate a sensing request towards a network system. The network system may, in some examples, be a 6G system. At step 1, the sensing request may be sent to the SCF 310. The sensing request may comprise information about mTSSA characteristics and/or an identity of a target WTRU 302. In some examples, the WTRU associated with the DT 314 may initiate the sensing request towards the network system (e.g., a 6G system), determine mTSSA characteristics, and enable, at this stage, a ProSe (Proximity-based services) discovery request so as to establish connections with surrounding WTRUs. In some examples, the target WTRU 302 may rely on previously-received configuration information to define the mTSSA. In some examples, the target WTRU may, as part of the determining the mTSSA characteristics, receive information about the characteristics, for example shape and size, of the mTSSA.

At step 2, in some examples, the SCF 310 may transmit to the target WTRU 302 (e.g., any one of WTRUs 102 of FIGS. 1A-1D) a sensing group request that may comprise the mTSSA characteristics retrieved from or based on the sensing request (if provided at step 1) in order to configure the target WTRU 302. In some cases, this may be done by using the identity of the target WTRU 302. Additionally or alternatively, the sensing group request may comprise a Sensing Group refresh rate (SG refresh rate), which may indicate to the target WTRU 302 on how often the target WTRU 302 is to report on a sensing group.

At step 3, the SCF 310 may send a Location Reporting Control query to the RAN node 306, directly or via any other network NW function and/or interface, using, e.g., a Location Reporting Control mechanism, in order to retrieve, from the RAN node 306, a location of the target WTRU 302, e.g., at a cell level. The Location Reporting Control query may include the identity of the target WTRU 302 and/or information associated with a requested area, e.g., an area where the target WTRU 302 is located. By providing the RAN node 306 with the identity of the target WTRU, the RAN node 306 may provide a list of WTRUs in the requested area, surrounding or close to the target WTRU 302. In some examples, the list of WTRUs in the requested area may be retrieved from the AMF 308. In some examples, the Location Report Control mechanism is used as an exemplary mechanism which may be enhanced with this functionality.

The information associated with the requested area may allow the RAN node 306 to determine the area where the target WTRU may be located. In an example, a cell is used, but in some cases the area may comprise a plurality of cells, a Tracking Area (TA), or any other representation. Furthermore, the SCF 310 may send a Location Reporting Control query to one or more RAN nodes 306. The list of WTRUs provided by the or each RAN node 306 may in some cases be encoded, e.g., any form of temporary identity mapping may be implemented at the RAN node 306 so that WTRU identity types which are used in the RAN node 306 may not necessarily be decoded by the AMF 308, SCF 310, or any other CN entity or function.

At Step 4, the RAN node 306 may send a location report to the SCF 310. The location report may comprise a location of the target WTRU 302, e.g., at a cell level, and/or a list of WTRUs in the requested area. In some instances, the list of WTRUs in the requested area may include one or more WTRUs known to the RAN node 306 which are to be connected to are or the under coverage of the same cell in which the target WTRU 302 is connected.

At step 5, the SCF may send, to the ProSeF 312, a ProSe discovery request, which may for example be a model A or model B ProSe discovery request to identify discoverer WTRUs 304 in proximity of the target WTRU 302. The ProSe discovery request may comprise the target WTRU 302 identity and/or the list of WTRUs (e.g., one or more discoverer WTRUs 304, and/or the target WTRU 302) in the requested area. Alternatively, a WTRU (e.g., the one or more discoverer WTRUs 304, the target WTRU 302) may trigger sending, to the ProSeF 312, of the ProSe discovery request in order to be announced.

At step 6, upon reception by the ProSeF 312 of the ProSe discovery request from the SCF 310, the target WTRU 302 may start an announcing procedure which may, for example, be an announcing scheme. In some cases, the discoverer WTRU 304 may start monitoring for the target WTRU 306.

At step 7, the target WTRU 302 and the one or more discoverer WTRUs 304 may end the ProSe discovery procedure, and a sidelink connection between the target WTRU 302 and the one or more discoverer WTRUs 304 may be established. The WTRUs 302, 304 may then exchange information over the sidelink connection. In addition, the one or more discoverer WTRUs 304 that ended the ProSe discovery procedure may, in some examples send to the ProSeF 312 an additional ProSe discovery request, which may include the identity of the target WTRU 302. This may allow for detecting more discoverer WTRUs 304 in proximity of the target WTRU 302, given that at least one of the more discoverer WTRUs 304 may have discovered the target WTRU 302 and may not have an active sidelink connection established with both the discoverer WTRUs 304 (previously identified) and the target WTRU 302.

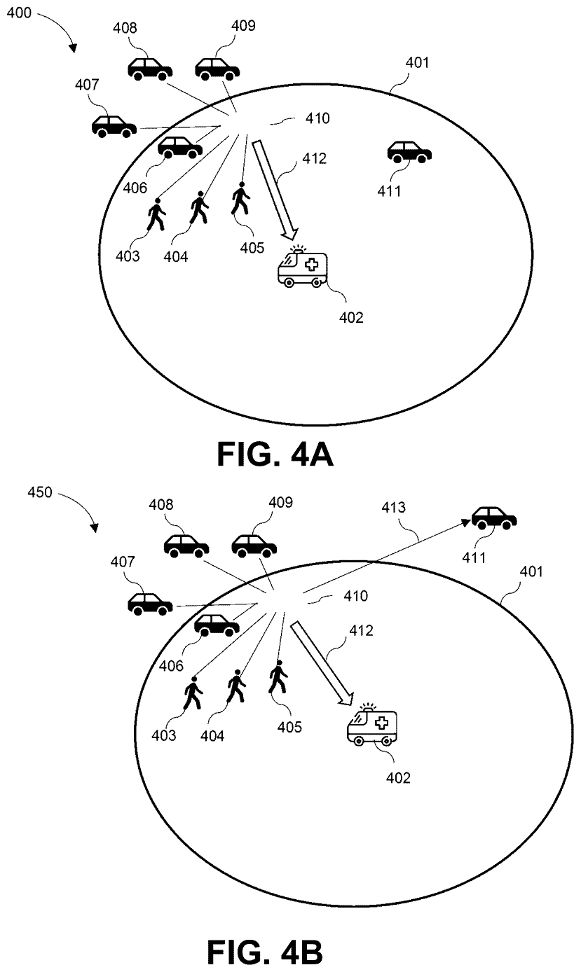

Turning to FIG. 4A, there is shown a diagram of an example system 400 illustrating a determination, by a target WTRU, of at least a subgroup (e.g., a sensing group) from a group of WTRUs, according to some examples of the present disclosure.

The example system 400 of FIG. 4A may include a group of WTRUs comprising, e.g., a target WTRU 402, WTRUs 403 to 409 and 411, and a discoverer WTRU 410. Target WTRU 402, WTRUs 403 to 406, and 411 and discoverer WTRU 410 may be located within a mTSSA 401 which may be the mTSSA described above in connection with FIG. 3. In the example shown in FIG. 4A, WTRUs 407 to 409 may be located outside mTSSA 401. Each WTRU of the group of WTRUs may be integrated, for example, in a vehicle, or may be a mobile phone, e.g., carried by a person or mounted on a vehicle. In some instances, discoverer WTRU 410 may be in a sidelink connection with each of WTRU 403 to 409 (as illustrated by lines linking discoverer WTRU 410 with WTRUs 403 to 409) while discoverer WTRU 410 may not be in a sidelink connection with WTRU 411.

When discoverer WTRU 410 discovers (e.g., determines a presence of) target WTRU 402, discoverer WTRU 410 and target WTRU 402 may communicate via sidelink connection. Discoverer WTRU 410 may be connected, via sidelink connection, to one or more other WTRUs, illustrated by arrow 412 indicating a transmission of information from discoverer WTRU 410 to target WTRU 402. In some examples this may include sidelink ranging information, and this may include location information. Such location information may comprise location results comprising at least a location result parameter or parameters which may, for example be range and direction, relative location, and/or relative velocity. Target WTRU 402 may check whether all WTRUs in the WTRUs list (e.g., that provided by discoverer WTRU 410) are within the mTSSA 401. This may, in some examples, be based on characteristics of the mTSSA 401, the WTRUs list, and/or ranging information.

In some cases, the one or more discoverer WTRUs 410 which established a sidelink connection transmit location results to the target WTRU 402, which may include one or more of relative location in relation to the target WTRU 402 or another WTRU with which the discoverer WTRU 410 has a sidelink established, relative velocity in relation to the target WTRU 402 or another WTRU with which the discoverer WTRU 410 has a sidelink established, range and direction in relation to target WTRU 402 or another WTRU with which the discoverer WTRU 410 has a sidelink established, and/or a list of WTRUs to which the location, velocity, range and direction pertain to. In an example shown in FIG. 4A, another WTRU 411 whose characteristics comply with the mTSSA characteristics, but may not have a sidelink connection established with the target WTRU 402 and discoverer WTRU 410 is shown.

Returning to a discussion of FIG. 3, at step 8, the one or more discoverer WTRUs 304 that established a sidelink connection may transmit location results to the target WTRU 302 which may include location result parameters as described in connection with FIG. 3. In some cases, the location results may comprise a list of WTRUs to which the at least a location result parameter pertains. In some instances, the location results may be derived from and pertain to any established sidelink connection between the target WTRU 302 and any discoverer WTRU 304. In some examples, the location results may relate to any established sidelink connection between a discoverer WTRU 304 and any other WTRU with which the discoverer WTRU 304 may have an active sidelink connection. For instance, FIG. 4A depicts a discoverer WTRU 410 which has a sidelink connection established with seven other WTRUs 403 to 409 different types, for example, a vehicle, a smartphone carried by a person such as a pedestrian, a cyclist, etc. A newly established link (e.g., represented as arrow 412 in FIG. 4A) between the target WTRU 302 (e.g., WTRU 402) and the WTRU (e.g., WTRU 410 of FIG. 4A) connected to a discoverer WTRU 304 (e.g., any one of WTRU 403 to 409) may be used for transferring location information (e.g., sidelink location information, location results). For each of the WTRUs to which the location results pertain, the discoverer WTRU 304 may also transmit an identity of the each WTRU.

At step 9, the target WTRU 302 may use location information received from one or more discoverer WTRUs 304 to derive a sensing group within the mTSSA. The sensing group may comprise a determined list of WTRUs within the mTSSA, e.g., the determined list being generated at step 8. The target WTRU 302 may determine the list by applying geometrical relationships between the target WTRU 302 and the one or more discoverer WTRUs 304. In some cases, the target WTRU may determine the list by applying geometrical relationships between the one or more discoverer WTRUs 304 and one or more other WTRUs, and a knowledge of the mTSSA. In some instances, the target WTRU 302 may determine the sensing group using pre-configured mTSSA and sidelink link ranging information. In some examples, the WTRU may derive a list of WTRUs within the mTSSA. In some examples, the sensing group may be derived from this list of WTRUs within the mTSSA.

Returning to a discussion of FIG. 4A, an exemplary mTSSA 401 is shown which is of elliptical shape, and the discoverer WTRU 410 may transmit location information pertaining to the discoverer WTRU 410 and/or to all WTRUs 403 to 409 of FIG. 4A. The discoverer WTRU 401 may transmit location information pertaining to WTRUs 403, 404, 405, 406, 407, 408, 409, and location information between the target WTRU 402 and the discoverer WTRU 410 may be determined by the target WTRU 410. With knowledge of the mTSSA shape and location information associated with the mTSSA, the target WTRU 410 may determine all WTRUs within the mTSSA.

In FIG. 4A, WTRUs 403 to 406, and WTRU 411 may have been discovered based on step 7 described herein.

Returning to a discussion of FIG. 3, at step 10, the target WTRU 302 may report on the determined sensing group to the SCF 310 or any other network entity. In some instances, the target WTRU 302 may transmit the list of WTRUs to the SCF 310.

At step 11, the sensing group may be formed and the SCF 310 may, as a result, have information about the sensing group within the mTSSA. In some embodiments, all of the WTRUs of the mTSSA are used as the sensing group. In other embodiments, a subset of the WTRUs of the mTSSA are used as the sensing group.

At step 12, in some cases at least one of sensing data, location results and contextual information may be requested and/or reported, providing sensing information to the network. In some examples, sensing data and/or location results may be exchanged between the SCF 310 (or, in some cases the SAF which may be SAF 188a, 188b of FIG. 1D) and the WTRUs within the mTSSA.

At step 13, the SCF 310 may expose at least one of sensing data, location results, and/or contextual information with the DT 314. In some cases, upon a request from the DT 314, the contextual information may be exposed to the target WTRU 302 or any other WTRU in the mTSSA. In some examples, where a DT 314 is not present, the target WTRU 302 may receive, from the network, at least one of the sensing data, the location results, and the contextual information.

In some examples, subsequent to determining the sensing group, the target WTRU 302 may determine an updated location of the target WTRU 302 and may determine updated configuration information which indicates an updated mTSSA based on the location of the target WTRU 302.

FIG. 4B is a diagram of an example system 450 illustrating a determination, by a target WTRU 402, similar to that shown in FIG. 4A. The example system 450 of FIG. 4B shows a group of WTRUs comprising a target WTRU 402, WTRUs 403 to 409 and 411, and a discoverer WTRU 410. Target WTRU 402, WTRUs 403 to 406, and discoverer WTRU 410 are, in the example shown, located within an mTSSA 401. WTRUs 407 to 409 and 411 are located outside the mTSSA 401. Differing from that which is shown in FIG. 4A, in this example, whilst WTRU 411 is outside mTSSA 401, the discoverer WTRU 410 may establish a sidelink connection with WTRU 411 as illustrated by arrow 413. In this example, a WTRU 411 which is outside of the mTSSA may still be used as part of the sensing group and be utilized for sensing.

FIG. 5 shows an illustration of new features 500 which may be utilized for sensing. WTRUs 502, 504 are shown, along with access node 506, sensing coordination function (SCF) 508, and sensing analytics function (SAF) 510. SCF 508 and SAF 510 may generally correspond to SCF 187a, 187b, and SAF 188a, 188b described in connection with FIG. 1D.

These features may enable broader sensing operations and are depicted in FIG. 5. This illustration of features 500 does not define the new system functionalities as new mobile network entities, but merely discusses their functionalities.

In some examples, the SCF 508 may coordinate a sensing operation in various respects which may, for example, include full management of sensing sources of sensing data, non-3GPP sensing data, sensing results, and sensing contextual information, including source selection, activation, de-activation, configuration and activation/de-activation of reporting from sources, etc., with the sources for example being an individual sensing transmitter, receiver, or a sensing group. Additionally or alternatively, the SCF may manage activation/de-activation and/or switching of sensing modes.

In some examples, the SAF 510 may perform, based on the collected sensing data and/or results, analytics over sensing data, sensing results, or both, and may be capable of generating additional sensing data, sensing results, and sensing contextual information. The SAF 510 may further generate insights over sensing data, results or contextual information, e.g., by applying statistical, probabilistic, or AI/ML methods in general. The SAF 510 may perform a fusion of sensing data from multiple sources, e.g., can combine different sensing data, results and/or contextual information from any sensing source and generate further data from that fusion process.

The SAF 510 may be able to expose the gathered or generated information to application servers in a data network (DN), for example via a network exposure function (NEF), and/or to an application function (AF).

In some examples, the SCF 508 and SAF 510 functionalities may reside within a core network (CN) which may be Core Network 115 of FIG. 1D. In some examples, the SCF 508 and SAF 510 may reside elsewhere, for example in the RAN domain. In the example shown in FIG. 5, SAF functionality is shown running in a WTRU 504.

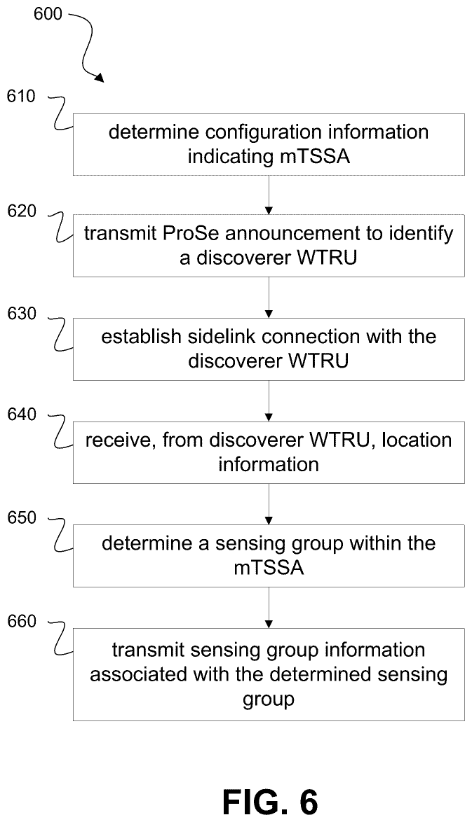

FIG. 6 is a flow diagram illustrating a method 600 for the setup of sensing groups in a moving target sensing service area according to one or more embodiments. The method 600 may, for example, be carried out by WTRUs 102 of FIGS. 1A-D, WTRU 203 of FIG. 2, WTRU 302 of FIG. 3, and WTRU 402 of FIGS. 1A-1B. The method 600 may include step 610. At step 610, the WTRU may determine configuration information indicating a moving target sensing service area (mTSSA) to be associated with the WTRU. In some examples, the WTRU may receive configuration information indicating the moving target sensing service area from the network. In some examples, the mTSSA is configured based on a pre-configured mTSSA. The mTSSA may be determined by the WTRU based on the status of the WTRU. For example, the WTRU may be a vehicle, and the vehicle may be driving along a road. The WTRU may make a determination that an mTSSA in front of the vehicle itself may be useful for self-driving purposes or, for example for aided navigation in poor weather conditions or poor visibility. In such an example, the mTSSA may be a cone or wedge shape before the vehicle, with a narrow point of the cone or wedge at the front of the vehicle and a wider part of the mTSSA extending away from the vehicle and into the direction of travel of the vehicle. Step 610 of method 600 may generally correspond to step 2 of FIG. 3 as described herein.

The WTRU may be located within the mTSSA. In some embodiments, the mTSSA may have a location, and the location may be determined relative to the WTRU. In some embodiments, the mTSSA may have an orientation, and the orientation may be determined based on a movement direction of the WTRU. This orientation may be a displacement orientation and may, for example, be a segment or sector of a circle, such that the segment or portion of the circle which forms the mTSSA has a particular displacement orientation with respect to the WTRU. For example, the mTSSA may be a segment of a circle in front of a WTRU in the direction of displacement or travel of the WTRU.

The method 600 may include step 620. At step 620, the WTRU may transmit a proximity-based service (ProSe) announcement to identify a discoverer WTRU. The ProSe announcement may be transmitted in accordance with techniques as described herein. Step 620 of method 600 may correspond generally to step 6 of FIG. 3 described herein.

The method 600 may include step 630. At step 630, the WTRU may establish a sidelink connection with the discoverer WTRU in accordance with techniques described herein. In some embodiments, establishing the sidelink connection may include the WTRU transmitting or receiving a request for a sidelink connection respectively to or from a discoverer WTRU which may, for example, be another WTRU 102 of FIG. 1B. Step 630 of method 600 may correspond generally to step 7 of FIG. 3 described herein.

The method 600 may include step 640, and at step 640, the WTRU may receive, from the discoverer WTRU, location information. This location information may be in accordance with that described herein. Step 640 of method 600 may correspond generally to step 8 of FIG. 3 as described herein.

The method 600 may include step 650, and at step 650, the WTRU may determine a sensing group within the mTSSA. This may be based on the received location information, and may be in accordance with techniques described herein. Step 650 of method 600 may correspond generally to step 9 of FIG. 3 as described herein.

The method 600 may include step 660, and at step 660, the WTRU may sensing group information associated with the determined sensing group to the wireless network. This may be in accordance with the techniques as described herein. Step 660 of method 600 may correspond generally to step 10 of FIG. 3 as described herein.

The method 600 may also include a step of the WTRU receiving sensing data or sensing results from a WTRU of the sensing group. The method 600 may also include a step of, subsequent to determining the sensing group, determining a location of the WTRU and determining updated configuration information indicating an updated mTSSA based on the location of the WTRU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method performed by a wireless transmit/receive unit (WTRU) in communication with a wireless network, the method comprising:
determining configuration information indicating a moving target sensing service area (mTSSA) associated with the WTRU;
transmitting a proximity-based service (ProSe) announcement to identify a discoverer WTRU;
establishing a sidelink connection with the discoverer WTRU;
receiving, from the discoverer WTRU, location information;
determining a sensing group within the mTSSA based on the received location information; and
transmitting sensing group information associated with the determined sensing group to the wireless network.

2. The method of claim 1, wherein determining the configuration information indicating the mTSSA comprises receiving configuration information from the wireless network.

3. The method of claim 1, wherein determining the configuration information indicating the mTSSA is based on a pre-configured mTSSA.

4. The method of claim 1, wherein the mTSSA has a location and wherein the location is determined relative to the WTRU.

5. The method of claim 4, wherein the WTRU is located inside or outside the mTSSA associated with the WTRU.

6. The method of claim 1, wherein the mTSSA has a displacement orientation and wherein the displacement orientation is determined based on a movement direction of the WTRU.

7. The method of claim 1, further comprising:
receiving sensing data or sensing results from a WTRU of the sensing group.

8. The method of claim 1, wherein the sensing group information comprises at least one of:
a relative location in relation to the WTRU or the discoverer WTRU;
a relative velocity in relation to the WTRU or the discoverer WTRU;
a range or direction in relation to the WTRU or the discoverer WTRU; or a list of WTRUs.

9. The method of claim 1, wherein determining the sensing group within the mTSSA based on the received location information comprises determining the sensing group within the mTSSA based on ranging information.

10. The method of claim 1, further comprising:
subsequent to determining the sensing group, determining a location of the WTRU; and
determining updated configuration information indicating an updated mTSSA based on the location of the WTRU.

11. A wireless transmit/receive unit (WTRU) in communication with a wireless network, the WTRU comprising:
a processor; and
a transceiver coupled to the processor, wherein the WTRU is configured to:
determine configuration information indicating a moving target sensing service area (mTSSA) associated with the WTRU;
transmit a proximity-based service (ProSe) announcement to identify a discoverer WTRU;
establish a sidelink connection with the discoverer WTRU;
receive, from the discoverer WTRU, location information;
determine a sensing group within the mTSSA based on the received location information; and
transmit sensing group information associated with the determined sensing group to the wireless network.

12. The WTRU of claim 11, wherein determining the configuration information indicating the mTSSA comprises receiving configuration information from the wireless network.

13. The WTRU of claim 11, wherein determining the configuration information indicating the mTSSA is based on a pre-configured mTSSA.

14. The WTRU of claim 11, wherein the mTSSA has a location and wherein the location is determined relative to the WTRU.

15. The WTRU of claim 14, wherein the WTRU is located inside or outside the mTSSA associated with the WTRU.

16. The WTRU of claim 11, wherein the mTSSA has a displacement orientation and wherein the displacement orientation is determined based on a movement direction of the WTRU.

17. The WTRU of claim 11, wherein the WTRU is further configured to receive sensing data or sensing results from a WTRU of the sensing group.

18. The WTRU of claim 11, wherein the sensing group information comprises at least one of:
a relative location in relation to the WTRU or the discoverer WTRU;
a relative velocity in relation to the WTRU or the discoverer WTRU;
a range or direction in relation to the WTRU or the discoverer WTRU; or a list of WTRUs.

19. The WTRU of claim 11, wherein determining the sensing group within the mTSSA based on the received location information comprises determining the sensing group within the mTSSA based on ranging information.

20. The WTRU of claim 11, wherein the WTRU is further configured to:
subsequent to determining the sensing group, determine a location of the WTRU; and
determine updated configuration information indicating an updated mTSSA based on the location of the WTRU.
